(19) United States
(12) Patent Application Publication
(10) Pub. No.: US 2024/0376923 A1
(43) Pub. Date: Nov. 14, 2024

(54) Self-Punching Functional Element

(71) Applicant: PROFIL Verbindungstechnik GmbH & Co. KG, Friedrichsdorf (DE)

(72) Inventors: Christian Sowa, Mühlheim a. Main (DE); Amer Mahlme, Bad Homburg (DE); Oliver Diehl, Usingen (DE); Tobias Jene, Friedrichsdorf (DE)

(21) Appl. No.: 18/645,648

(22) Filed: Apr. 25, 2024

(30) Foreign Application Priority Data
May 11, 2023 (DE) 102023112481.1
May 11, 2023 (DE) 102023112483.8

(51) Int. Cl. F16B 19/08; F16B 37/06

(52) U.S. Cl. CPC F16B 19/086; F16B 37/064

(57) ABSTRACT

The present invention relates to a functional element that is configured for attachment to a workpiece, in particular to a sheet metal part, said functional element comprising a head part having a contact surface that contacts the workpiece in a fastened state of the functional element, A fastening section extends in an axial direction from the head part, in particular a rivet section, for fastening the functional element to the workpiece. The fastening section comprises a wall that bounds a hollow space in a peripheral direction and that has a free edge at a side facing away from the head par. The wall has opposing curved sections terminating at the free edge. The free edge lies along a peripheral curved line that has curved peaks and valleys which is endless and continuous. The peaks and valleys may be axially or radially extending, or both.

The invention relates to a functional element for attachment to a workpiece.

Functional elements are used in a variety of applications, in particular in automotive engineering. They, for example, serve to create fastening options for other workpieces at a workpiece, e.g. at a sheet metal part, or to provide other functionalities that cannot be easily developed at the workpiece itself or only with great effort. In this respect, it is naturally important that the elements can be efficiently connected to the respective workpiece. The connection must also be resilient and reliable.

Functional elements can, for example, be bolt elements whose shafts can be provided with a thread or nut elements that can, for example, have an internal thread. Other designs are conceivable. For example, functional elements can also have components or sections that are intended for a snap-in or plug-in connection.

Functional elements are known in different designs. There are, for example, rivet elements that have a rivet section that is deformed on the attachment to a sheet metal part to form a rivet bead and to form, with a head part, a ring-shaped receiver for the margin of a hole in the sheet metal part. With such rivet elements, the functional element is therefore deformed on the attachment to the sheet metal part. The deformations of the rivet section can be considerable in many cases. During such reshaping processes, considerable shear forces occur in the rivet section that can cause weakening, which in turn can have a detrimental effect on the connection between the element and the workpiece. The rivet section must therefore contain sufficient material to absorb this reshaping.

Rivet elements can be self-punching. This means that there does not have to be a prepared hole in the workpiece into which the rivet section is introduced, but the rivet section—to put it bluntly—punches its own hole. As there is no need to pre-punch the workpiece, one work step can be saved, which results in a cost advantage. However, the rivet section of a self-punching rivet element must be sufficiently stable so that it does not deform in an undesirable way when it is punched into the workpiece and the punching slug is removed.

Rivet sections that are significantly reshaped during the fastening process and/or self-punching rivet sections therefore have a high degree of stability, which in turn means that considerable forces (setting forces) must be applied when fastening the corresponding elements to reliably reshape the rivet section. The setting devices used must therefore be designed with the appropriate performance.

It is an object of the present invention to provide a functional element of the initially described kind that can be fastened to a workpiece with a smaller exertion of force without compromising the reliability of the connection element-workpiece connection.

This object is satisfied by a functional element having the features of claim 1.

The functional element according to the invention is provided for attachment to a workpiece, in particular to a sheet metal part. It comprises a head part having a contact surface that contacts the workpiece in a fastened state of the functional element. Furthermore, a fastening section extending in an axial direction from the head part, in particular a rivet section, for fastening the functional element to the workpiece is provided. The fastening section comprises a wall that bounds a hollow space in a peripheral direction and that has a free edge at a side facing the contact surface, wherein the wall has opposing curved sections terminating at the free edge, and wherein the free edge lies along a peripheral wavy curved line having curved peaks and valleys that is endless and continuous.

The wording “a fastening section extending in an axial direction from the head part” is in particular to be understood as the wall of the fastening section extending in parallel with the axial direction.

On the one hand, this design offers security against rotation. On the other hand-and this is particularly important for rivet elements-more material is thereby available than e.g. with a circular design of the wall (assuming a comparable wall thickness) so that stresses occurring during a reshaping of the wall can be better absorbed. The wall can therefore be designed as thinner-walled with the same load-bearing capacity.

Furthermore, the fastening section is not simultaneously reshaped as a whole by a die with a circular geometry, for example. A gradual reshaping of the section with an increasing penetration depth of the element into the workpiece takes place. The force applied by the setting device is thus not uniformly distributed when the fastening section cooperates with the die, but “migrates” radially outwardly during the fastening process from the radially inwardly disposed ends of the curved sections that are the first to cooperate with the die. The radially outer ends of the curved sections are reshaped last.

The geometry of the curved sections therefore determines how the reshaping forces are distributed in time and space during the reshaping process. Or, in other words: The punching and/or reshaping process can be optimized by suitably selecting the geometry of the punching edge and/or the wall. The focusing of the reshaping forces also enables an optimum utilization of the forces that can be applied by the setting device.

Further embodiments of the invention are set forth in the claims, in the description and in the enclosed drawings.

According to one embodiment, the edge has a corrugated or serrated shape in a side view perpendicular to the axial direction.

The edge and/or the wall is/are preferably designed as rotationally symmetrical with respect to a center axis of the functional element. This means that by rotating the fastening section by an angle of 360°/X (X is a natural number) about the center axis, the contour of the fastening section is mapped back onto itself.

According to a further embodiment, a spacing of the edge from the head part is not constant in the peripheral direction and/or the edge, viewed in the peripheral direction, does not lie completely in a plane that is arranged perpendicular to a longitudinal axis or to a setting direction of the functional element.

This design is in particular advantageous if the edge is a punching edge and the functional element is self-punching. Due to the specific design of the punching edge, it at least does not contact the surface of the workpiece with its full periphery at the start of the punching process. This means that the applied punching force is concentrated on a smaller contact region than during a simultaneous contact of the entire punching edge. This in turn means that—with the same punching force—stronger forces act between the punching edge and the workpiece than with conventional elements.

Or, in other words: Due to the design of the functional element with a punching edge that, viewed in the peripheral direction, does not lie completely in a plane that is arranged perpendicular to a longitudinal axis or to a punching direction of the element, a fastening to firmer workpieces is ultimately made possible in a simple manner without greater punching forces having to be applied by the punching device used. Figuratively speaking, this is achieved by a focusing of the forces onto certain regions of the punching edge. The geometry of the punching edge, i.e. its variation—viewed in the peripheral direction—of the axial extent defines when which sections of the punching edge come into contact with an entry side of the workpiece during the punching process and leave it again at the exit side. The thickness of the workpiece also plays a role here. By selecting the geometry of the punching edge, the punching process can thus be intentionally influenced to achieve an optimal result.

The punching process thus does not start at the same time everywhere in the peripheral direction of the punching edge.

The same applies to an initiation of the reshaping process of the fastening section if it is configured as a (self-punching or non-self-punching) rivet section. The sections of the edge that are axially furthest from the head part are the first to cooperate with a die that is circular, for example. In other words, the reshaping of the rivet section does not start at the same time everywhere in the peripheral direction, which is accompanied by a substantial and somewhat sudden increase in the acting forces, but “migrates” depending on the selected geometry of the edge. This has the result that the forces increasing due to the interaction with the die are distributed in space and time. The maximum forces and loads that occur and have to be applied are therefore reduced.

According to one embodiment, the edge comprises sections curved in the axial direction and/or sections inclined relative to the axial direction. Sections can also be provided that extend perpendicular to the longitudinal axis or to the fastening direction of the element.

For example, the edge has a corrugated or serrated course in a side view perpendicular to the axial direction.

In many applications, it is advantageous if the edge is free of discontinuities in the axial direction and/or in the peripheral direction to avoid starting points for weakening the wall.

The edge can merge into an outer side of the wall via a curved outer transition section or a (conical) transition section (e.g. a chamfer) that is straight but inclined relative to the axial direction. Alternatively, or additionally, the edge can merge into an inner side of the wall facing the hollow space via an inner transition section that is straight but inclined relative to the axial direction. These measures serve to simplify the insertion of the element into a prefabricated hole or to improve the punching process.

According to a structurally simple and efficient embodiment, the wall has a substantially constant thickness in the peripheral direction.

The contact surface can be ring-shaped. It can be provided with at least one feature providing security against rotation, in particular with a plurality of features providing security against rotation that are preferably regularly distributed in the peripheral direction. Exemplary features of this kind are grooves, notches, ribs, protrusions or tips. They can be combined with one another as desired.

The contact surface can have a groove extending in the peripheral direction. It can also be designed as conically inclined, wherein it can converge or diverge in the direction of the edge.

According to an embodiment, the head part comprises a functional section. Alternatively or additionally, a functional section can extend from the side of the head part facing away from the fastening section.

The functional element can be a nut element or a bolt element.

As already mentioned, the free edge can be a punching edge so that the functional element is self-punching.

The present invention will be explained in the following purely by way of example with reference to advantageous embodiments and to the enclosed drawings. There are shown:

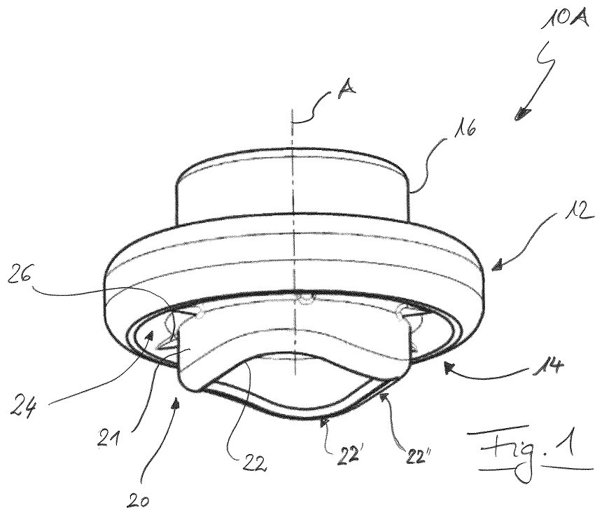

FIG. 1 a nut element comprising a punching edge corrugated in the axial direction in a perspective view;

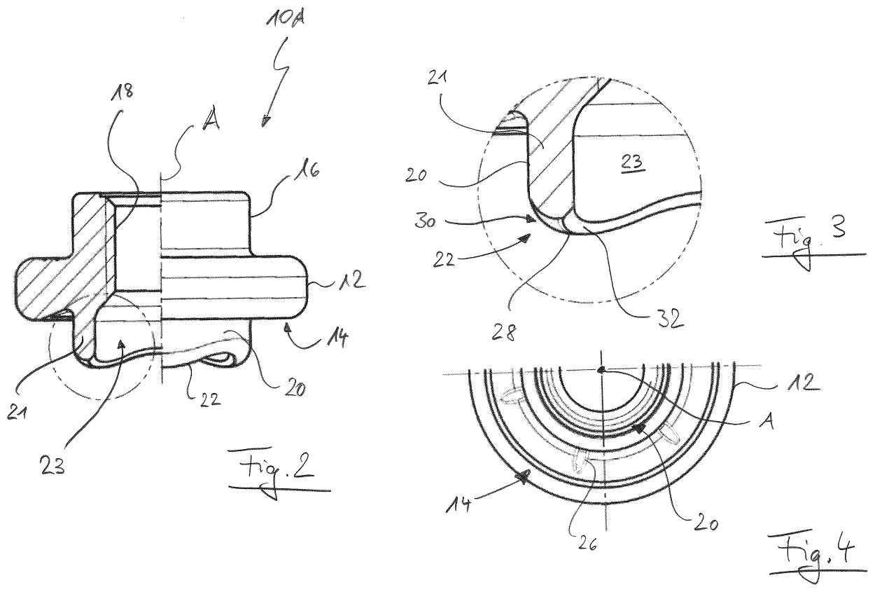

FIG. 2 a partly sectional side view of the element in accordance with FIG. 1;

FIG. 3 an enlargement of a section of FIG. 2;

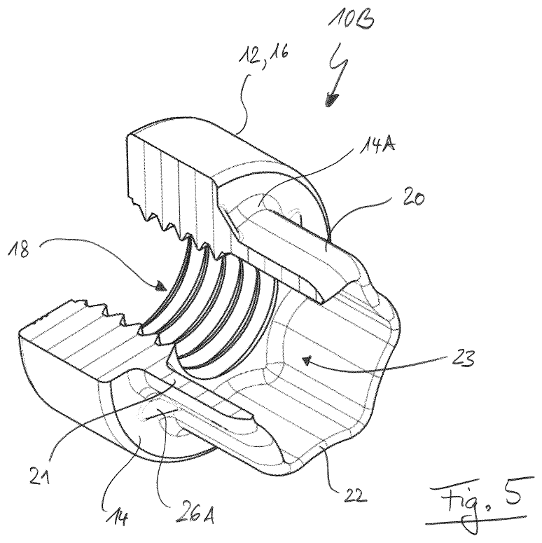

FIG. 4 a partly axial view of the element in accordance with FIG. 1;

FIG. 5 a partly sectional perspective view of a nut element with a fastening section corrugated in the peripheral direction;

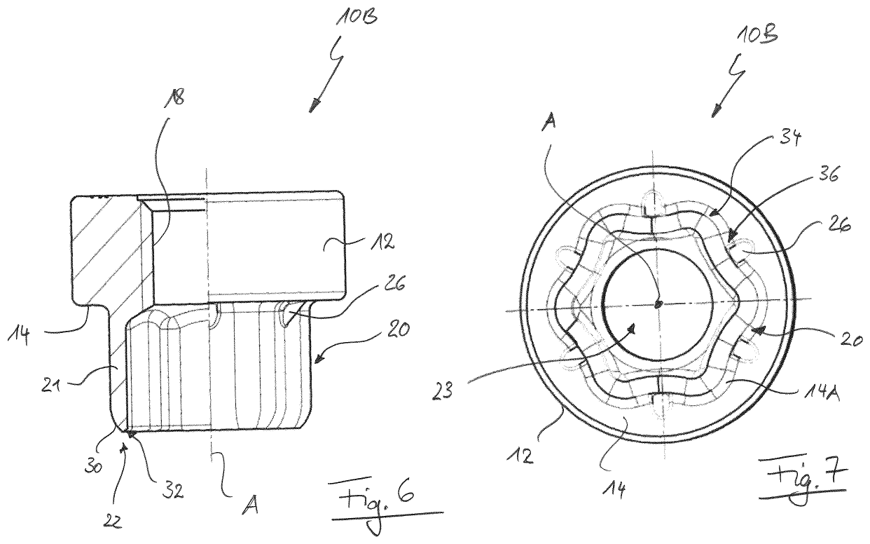

FIG. 6 a partly sectional side view of the element in accordance with FIG. 5;

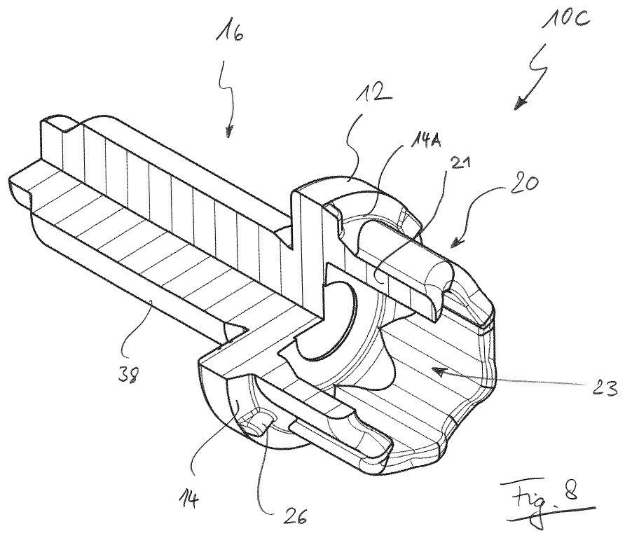

FIG. 7 an axial view of the element in accordance with FIG. 5;

FIG. 8 a partly sectional perspective view of a bolt element comprising a rivet section that is corrugated in the peripheral direction and that has a punching edge corrugated in the axial direction;

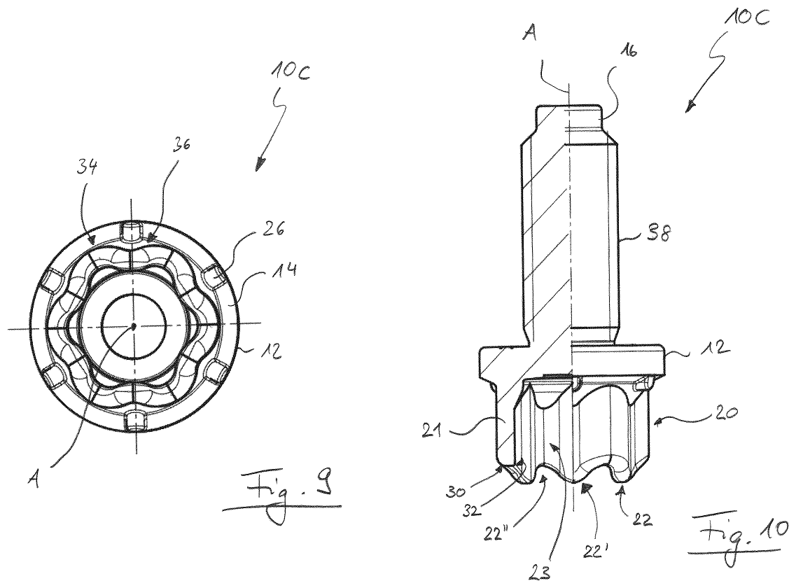

FIG. 9 an axial view of the element in accordance with FIG. 8; and

FIG. 10 a partly sectional side view of the element in accordance with FIG. 8.

FIG. 1 shows a functional element 10A comprising a head part 12 that has a contact surface 14 that contacts a workpiece (not shown) in a fastened state of the element 10A.

A functional section 16, which supports an internal thread 18 in the present example (see FIG. 2), extends from the head part 12 from the side facing away from the contact surface 14 in the axial direction A (the center axis of the element 10A is drawn).

A fastening section 20, which is configured as a rivet section in the present example, extends from the oppositely disposed side of the head part 12. The fastening section 20 is formed by a wall 21 that bounds a hollow space 23 in the peripheral direction.

A punching edge 22 is formed at the free end of the wall 21 or the fastening section 20. It enables the element 10A to be punched into a workpiece (not shown). This means that there does not have to be a prefabricated hole into which the element 10A is inserted. Due to its self-punching properties, the element 10A forms its own hole by cutting out a slug. During the punching process, the fastening section 20 is also at least sectionally beaded over by a suitable die in a manner known per se so that an undercut is created through which the element 10A is fixed to the workpiece.

For an improved fixing of the element 10A to the workpiece, the contact surface 14 is provided with a groove 24 running around the fastening section 20. Ribs 26 extending in a radial direction are arranged in the groove 24. During the fastening process of the element 10A, material of the workpiece is pressed into the groove 24, wherein the ribs 26 dig into the material. A reliable securing of the element 10A against a rotation relative to the workpiece is thereby produced. It is understood that additional or alternative features providing security against rotation can be provided. Different types of features having wavy elevated portions and depressions (i.e. peaks and valleys) of any geometry-can be combined in this respect. The contact surface 14 does not necessarily have to have a peripheral groove 24. It can also be designed as substantially planar or conical, for example.

Features providing security against rotation can also be provided at the outer side of the fastening section 20, e.g. in the form of ribs and/or grooves (not shown) extending in the axial direction.

Unlike conventional functional elements, the punching edge 22 does not lie in a plane that is arranged perpendicular to the axial direction A, but lies along an endless peripheral curved line. If one looks at the element 10A from the side, it can be seen that the punching edge 22 has a corrugated shape (see also FIG. 2). This means that the spacing of the punching edge 22 from the head part 12 is therefore not constant, but varies as it proceeds in the peripheral direction with peaks and valleys forming maxima and minima, respectively. The punching edge viewed in the peripheral direction does not lie completely in a plane that is arranged perpendicular to a longitudinal axis or to a punching direction of the functional element. In the present embodiment, three maxima 22′ thereby result that are separated from one another by three minima 22″. It is understood that the number of maxima 22′ and minima 22″ can be selected as required.

The number can be even or odd. Instead of a uniform or rotationally symmetrical arrangement, an irregular arrangement and/or design of the maxima 22′ and/or minima 22″ can also be selected. It is also possible, for example, to design the maxima 22′ (or one maximum 22′ or some of the maxima 22′) longer viewed in the peripheral direction than the minima 22″ (or one minimum 22″ or some of the minima 22″), or vice versa.

In a setting process, the maxima 22′ are the first to come into contact with the surface of the workpiece. The entire setting force, which is applied by the corresponding setting device (not shown), is thus initially concentrated on these maxima 22′. With conventional elements, the setting force is, however, uniformly distributed over the entire punching edge. This in turn means that the functional element 10A can be inserted into the workpiece more easily, especially at the start of the setting process that is particularly critical in many cases.

During the setting process, further sections of the punching edge 22 come into contact with the workpiece. With a suitable amplitude of the maxima 22′ and minima 22″ and a corresponding thickness of the workpiece, the situation can arise that the maxima 22′ already exit the workpiece again before the deepest regions of the minima 22″ enter the workpiece. In such cases, the entire punching edge 22 is not involved in the punching at any point during the setting process, but only part sections thereof. However, provision can also be made that the entire punching edge 22 is involved in the separation of the slug from a certain point of the setting process.

This situation is very similar when the punching edge 22 begins to cooperate with a die (not shown, for example a conventional die with a circular geometry) so that a reshaping of the fastening section 20 begins. The maxima 22′ are the first to cooperate with the die. In other words, the reshaping of the section 20 does not start at the same time everywhere in the peripheral direction, which is accompanied by a substantial and somewhat sudden increase in the acting forces, but “migrates” to the minima 22″. As a result, the forces increasing due to the cooperation with the die are distributed in space and time, which overall leads to a reduction in the occurring loads.

In other words, the functional element 10A can be inserted into firmer workpieces without having to increase the setting force to be applied.

FIG. 2 shows a side view of the functional element 10A, wherein the left side of the element 10A is shown in section. In this view, it can be seen that the head part 12 forms a kind of flange from which the functional section 16 and the fastening section 20 extend in different directions. As already explained, the functional section 16 is provided with the internal thread 18 that, in the example shown, extends up to and into the region of the head part 12. Instead of the internal thread 18, for example, a latch section or a section with a different functionality can also be provided. Instead of the functional section 16 with an axial passage opening, it is also conceivable to provide a bolt section that, for example, provides functionalities at its outer periphery, such as a thread or similar.

The corrugated character of the punching edge 22 is also clearly visible.

FIG. 3 shows a section of FIG. 2 to explain the design of the punching edge 22 in more detail. It has a curved transition section 30 in a transition from a radial outer surface of the fastening section 20 to an edge line 28. Starting from the edge line 28 to a radial inner surface of the fastening section 20, a slanted or conical transition section 34 is provided. The design of the transition sections 32, 34 improves the punching effect of the punching edge 22—both individually but in particular in combination with one another. The free edge and/or the wall comprises/comprise sections curved concavely and convexly in the peripheral direction.

FIG. 4 shows a part of an axial view of the functional element 10A with a view of the fastening section 20 and the contact surface 14. The groove 24, which surrounds the fastening section 20 had a groove base with ribs 26 provided to effect security against rotation, is clearly visible.

FIG. 5 shows a partly sectioned perspective view of a functional element 10B configured as a nut element and having a fastening section 20 corrugated in the peripheral direction or in other words as seen from an axial sectioned view. The corrugation of the punching edge 22 corresponds to that of the wall 21 and forms a compound configuration in both the axial and radial directions—figuratively speaking—a “flower shape”.

In this embodiment, the head part 12 comprises the functional section 16 that is in turn provided with an internal thread 18. One end of the thread 18 still projects slightly into the fastening section 20, i.e. a small part of the thread 18 is formed by a head-side end of the wall 21.

The contact surface 14—unlike that of the functional element 10A—does not have a groove. It merges via a curvature 14A into the fastening section 20. Furthermore, inclined or slanted ribs 26 are provided that dig into the side wall of the punched-out hole when the element 10B is fastened to effect security against rotation.

Unlike the functional element 10A that has a circular fastening section 20, the fastening section 20 is corrugated (has elevated portions and depressions) and in the peripheral direction as seen from an axial view. This can also be easily seen in FIG. 7. It shows that comparatively more greatly curved bulges 34 and less strongly curved indentations 36 alternate, viewed in the peripheral direction wherein the fastening section has a corrugated outer wall comprising axially extending radial bulges and indentations which can differ in their respective degree of curvature. The ribs 26 are in each case are arranged at the center of the indentations 36.

Due to the selected design of the fastening section 20, more material is available for reshaping it during the fastening process than for a round fastening section with a comparable wall thickness. Stresses occurring in the material of the fastening section 20 during the reshaping can thus be better absorbed, which ultimately leads to an improvement in the reliability of the connection of the element 10B to the corresponding workpiece. In other words: Due to the additional material, a load on the fastening section 20 is reduced by the reshaping or the fastening section 20 can be designed as thinner-walled with the same load-bearing capacity.

Furthermore, the fastening section 20 configured as a rivet section is not simultaneously reshaped as a whole by a die with a circular geometry, for example. A gradual reshaping of the section 20 takes place as the penetration depth of the element 10B increases. This in turn means that the forces required for reshaping the section 20 are focused. The force applied by the setting device is thus not uniformly distributed when the section 20 cooperates with the die, but “migrates” radially outwardly during the fastening process from the radially inwardly disposed ends of the indentations 36 that are the first to cooperate with the die. The radially outer ends of the bulges 34 are reshaped last.

The geometry of the indentations 34 and bulges 36 therefore determines how the reshaping forces are distributed in time and space during the reshaping process. Or, in other words: The punching and/or reshaping process can be optimized by suitably selecting the geometry of the punching edge and/or the wall. The focusing of the reshaping forces also enables an optimum utilization of the forces that can be applied by the setting device.

It can very generally be stated that the above-described concept of a fastening section corrugated in the peripheral direction cannot only be used with a self-punching element. It can also be considered for an element that is inserted into a prefabricated hole. The edge 22 would then not have to be designed as a punching edge. However, it could, for example, be provided with an insertion aid (e.g. with an outer peripheral chamfer) to make it easier to insert it into the prefabricated hole.

It is understood that the number of bulges 34 and indentations 36 can be selected as required. The number can be even or odd. Instead of a uniform or rotationally symmetrical arrangement, an irregular arrangement and/or design of the bulges 34 and/or indentations 36 can also be selected. It is, for example, also possible to design the bulges 34 (or one bulge 34 or some of the bulges 34) longer viewed in the peripheral direction than the indentations 36 (or one indentation 36 or some of the indentations 36), or vice versa.

It can be seen from FIG. 6 that in this embodiment the curved transition section 30 of the punching edge 22 is less strongly curved than the corresponding section 30 of the element 10A. The slanted or conical transition section 32 is also formed differently from that of the element 10A; it is less steep. This makes it clear that the design of the transition sections 30, 32 can be adapted as required to the respective requirements in order to achieve an optimum punching result. Among other things, the properties of the workpiece (e.g. material properties or sheet metal thickness) must also be considered.

FIG. 8 shows a sectional element 10C configured as a bolt element. A functional section 16, which is provided with an external thread 38, extends from the head part 12 of the element 10C. The contact surface 14 is provided at the side of the head part 12 disposed opposite the functional section 16. It merges with a comparatively pronounced curvature 14A into the fastening section 20. Ribs 26 uniformly distributed in the peripheral direction extend from the contact surface 14, but—unlike the ribs of the element 10B—have a free edge oriented perpendicular to the axial direction A. The contact surface 14 is further designed as conical. In other words, the contact surface 14 converges in the viewing direction from the head part 12 to the punching edge 22 (see also FIG. 10). A divergent design (possibly with the formation of a groove) is likewise conceivable. It should be added that the contact surface 14 can also only sectionally (in the peripheral and/or radial direction) be conical.

The fastening section 20 extends from the contact surface 14 in the axial direction A and combines some characteristics of the fastening sections 20 of the elements 10A, 10B. On the one hand, it is corrugated radially in the peripheral direction; on the other hand, its punching edge 22 also has an axially corrugated shape.

The hollow space 23 bounded by the head part 12 and the fastening section 20 can receive the slug after its separation; i.e. in certain applications, the slug can remain in the hollow space 23. It is not absolutely necessary to remove it since the functional element 10C is a bolt element without an axial passage opening that may often not be blocked by the slug in the case of nut elements.

FIG. 9 shows a part of an axial view of the functional element 10C in a view of the fastening section 20 and the contact surface 14. Curved bulges 34 and curved indentations 36 (6 of each) can again be seen, wherein their curvatures differ less than in the element 10B (see FIG. 7). The ribs 26 are arranged at the center of the indentations 36.

FIG. 10 shows a partly sectioned side view of the functional element 10C. It can be seen, among other things, that the amplitude of the axial corrugation of the punching edge 22 is more pronounced than in the element 10A (see e.g. FIG. 2). This makes it clear that there is also considerable freedom of design in this respect to adapt the respective element to the specifically present conditions or workpiece.

The conical design of the contact surface 14 can also be clearly seen in FIG. 10. The punching edge 22 of the element 10C also differs from the corresponding designs of the elements 10A and 10B in terms of its specific design. The curved transition section 30 flattens radially inwardly. Furthermore, the radially inwardly disposed transition section 32 is only formed very weakly here.

The present invention was described purely by way of example with reference to three advantageous embodiments. However, it is understood that the design of the punching edge 22 can be freely selected with respect to the transition sections 30 and 32. It may also be provided that both transition sections 30, 32 are curved or slanted or that the transition section 30 forms a slope, whereas the transition section 32 is curved.

The axial corrugation of the punching edge 22 can likewise be selected as required. Rotationally symmetrical designs are just as conceivable as asymmetrical designs. The number of “waves” can likewise be easily adapted to the respective present conditions. It is indeed preferred that the punching edge 22 has no waves or jumps in the axial direction. In certain applications, however, such a design can also be advantageous.

The above statements regarding the axial corrugation-wavy as seen from a side view—of the punching edge 22 apply analogously to the design of the corrugation of the punching edge 22 and/or of the wall of the fastening section 20 in its peripheral direction—wavy as seen from an axial sectional view-.

The above-described embodiments of the transition sections, of the axial corrugation, of the corrugation in the peripheral direction, of the contact surface, of the features providing security against rotation, of the head part and of the functional section can be freely combined with one another to create a self-punching functional element that is optimized for the respective application.

### Reference Numeral List

10A, 10B, 10C functional element
12 head part
14 contact surface
14A curvature
16 functional section
18 internal thread
20 fastening section
21 wall
22 punching edge
23 hollow space
22′, 22″ maximum/minimum
24 groove
26 rib
28 edge line
30, 32 transition section
34 bulge
36 indentation
38 external thread
A axial direction, center axis

1. A functional element for attachment to a workpiece, said functional element comprising:
a head part having a contact surface that contacts the workpiece in a fastened state of the functional element,
a fastening section extending in an axial direction from the head part for fastening the functional element to the workpiece, wherein the fastening section comprises a wall that bounds a hollow space in a peripheral direction and that has a free edge at a side facing away from the head part, wherein the wall has opposing curved sections terminating at the free edge; and,
wherein the free edge lies along a wavy peripheral curved line that is endless and continuous.

2. The functional element according to claim 1, wherein the free edge has a corrugated shape with curved peaks and valleys in the axial direction.

3. The functional element according to claim 1, wherein the free edge is rotationally symmetrical with respect to a center axis of the functional element.

4. The functional element according to claim 1, wherein the free edge does not lie completely in a plane perpendicular to a longitudinal axis of the functional element.

5. The functional element according to claim 4, wherein the free edge comprises sections curved in the axial direction.

6. The functional element according to claim 1, wherein the free edge has a corrugated shape in a side view perpendicular to the axial direction.

7. The functional element according to claim 1, wherein the free edge and/or the wall comprises/comprise sections curved concavely and convexly in the peripheral direction.

8. The functional element according to claim 1, wherein the free edge merges into an inner side of the wall facing the hollow space by way of an inner transition section that is straight but inclined relative to the axial direction.

9. The functional element according to claim 1, wherein the wall has a substantially constant thickness.

10. The functional element according to claim 1, wherein the head part contact surface is provided with at least one feature providing security against rotation of the functional element relative to an attached workpiece.

11. The functional element according to claim 10, wherein the head part contact surface is provided with a plurality of features providing security against rotation that are regularly distributed in the peripheral direction.

12. The functional element according to claim 1, wherein the head part contact surface is conically inclined.

13. The functional element according to claim 1, wherein the head part contact surface is conically inclined and converges towards the fastening section.

14. The functional element according to claim 1, wherein the free edge is a punching edge so that the functional element is self-punching.

15. The functional element according to claim 14, wherein a spacing of the punching edge from the head part is not constant in the peripheral direction and/or wherein the punching edge viewed in the peripheral direction does not lie completely in a plane that is arranged perpendicular to a longitudinal axis or to a punching direction of the functional element.

16. The functional element of claim 1, wherein the fastening section has a corrugated outer wall comprising axially extending radial bulges and indentations that are each radially curved.

17. The functional element of claim 16, wherein the bulges and indentations differ in axial length.

18. The functional element of claim 2, wherein the fastening section has a corrugated outer wall comprising axially extending radial bulges and indentations that are curved in a radial plane and differ in their respective curvatures.

19. The functional element of claim 16 wherein the indentations and bulges differ in their respective degree of curvature.

20. The functional element of claim 2, wherein the free edge merges into an inner side of the wall by way of an inner transition section that is straight but inclined relative to the axial direction.
